(19) United States
(12) Patent Application Publication
(10) Pub. No.: US 2012/0167736 A1
(43) Pub. Date: Jul. 5, 2012

(54) CUTTING SYSTEM

(75) Inventor: Keijiro Yokoe, Kanonji-shi (JP)

(73) Assignee: UNICHARM CORPORATION, Shikokuchuo-shi, Ehime (JP)

(21) Appl. No.: 13/395,455

(22) PCT Filed: Aug. 30, 2010
(86) PCT No.: PCT/JP2010/065188

§ 371 Date: Mar. 12, 2012

(30) Foreign Application Priority Data
Sep. 18, 2009 (JP) 2009--217748

(51) Int. Cl. B26D 1/62; B26D 7/00

(52) U.S. Cl. 83/348

(57) ABSTRACT

A cutting system (1) is provided with a cutter roll (2) and anvil roll (3) rotating in opposite directions to each other about substantially parallel axes of rotation. These cutter roll (2) and anvil roll (3) respectively carry a cutting blade (2e) and a receiving blade (3e). A material to be cut which is fed between these cutter roll (2) and anvil roll (3) is cut by the facing cutting blade (2e) and receiving blade (3e). The receiving blade (3e) can elastically displace in a radial direction of the anvil roll (3).

### TECHNICAL FIELD

The present invention relates to a cutting system.

### BACKGROUND ART

Known in the past has been a cutting system provided with a cutter roll and an anvil roll rotating in opposite directions to each other about substantially parallel axes of rotation, the cutting system cutting a material to be cut which is fed between these cutter roll and anvil roll, by a cutting blade carried on the cutter roll.

In this regard, if the cutting system is continuously operated over a long period of time, the cutter roll will gradually expand due to heat so the clearance between the cutting blade and circumferential surface of the anvil roll is liable to become smaller. As a result, the cutting blade is liable to become remarkably worn or chipped and the lifetime of the cutting blade is liable to become remarkably shorter. On the other hand, if the clearance is set large in advance, the material to be cut is liable not to be able to be reliably cut.

Therefore, there is known a cutting system designed to run coolant through the cutter roll so as to suppress heat expansion of the cutter roll (see PLT 1).

### CITATION LIST

### Patent Literature

PLT 1: Japanese Unexamined Patent Publication No. 2001-38675

### SUMMARY OF INVENTION

### Technical Problem

However, in the cutting system of PLT 1, the configuration is liable to become complicated and the running costs to become high. Further, vibration, bending, etc. of the cutter roll and anvil roll result in constant fluctuation of the clearance, so even if suppressing heat expansion of the cutter roll, it would be difficult to sufficiently suppress wear and chipping of the cutting blade.

### Solution to Problem

According to one aspect of the present invention, there is provided a cutting system provided with a cutter roll and an anvil roll rotating in opposite directions to each other about substantially parallel axes of rotation, these cutter roll and anvil roll respectively carrying a cutting blade and receiving blade, the cutting system cutting a material to be cut which is fed between these cutter roll and anvil roll, by the facing cutting blade and receiving blade, wherein the receiving blade can elastically displace in a radial direction of the anvil roll.

Further, according to another aspect of the present invention, there is provided a cutting system provided with a cutter roll and an anvil roll rotating in opposite directions to each other about substantially parallel axes of rotation, the cutting system cutting a material to be cut which is fed between these cutter roll and anvil roll, by a cutting blade carried on the cutter roll, wherein the cutting blade can elastically displace in a radial direction of the cutter roll.

### ADVANTAGEOUS EFFECTS OF INVENTION

It is possible to secure good cutting of the material to be cut while extending the lifetime of the cutting blade by a simple configuration.

### BRIEF DESCRIPTION OF DRAWINGS

FIG. 1 is an overall view of a cutting system.

FIG. 2 is a cross-sectional view along the line II-II of FIG. 1.

FIG. 3 is an enlarged view of a part III of FIG. 2.

FIG. 4 is a cross-sectional view similar to FIG. 3 for explaining an embodiment according to the present invention.

FIG. 5 is a view showing another embodiment according to the present invention.

FIG. 6 is a view showing still another embodiment according to the present invention.

### EMBODIMENTS OF INVENTION

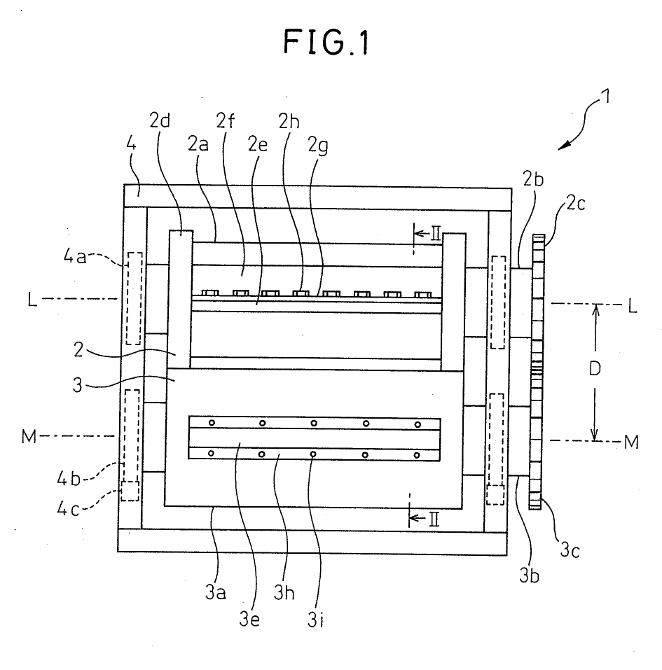

FIG. 1 shows a cutting system of an embodiment according to the present invention. This cutting system 1 is for cutting a material to be cut having a belt shape into a plurality of cut parts. Here, the material to be cut is for example comprised of at least one member selected from a nonwoven fabric, paper, fiber aggregate, and plastic film. A fiber aggregate is comprised of natural fibers or synthetic fibers and includes tows, card webs, sliders, etc. where the fibers are not bonded with each other.

Referring to FIG. 1, the cutting system 1 is provided with a cutter roll 2 and anvil roll 3 arranged aligned in the vertical direction. These cutter roll 2 and anvil roll 3 are respectively supported at a frame 4 to be able to rotate about substantially parallel direction axes of rotation L and M, therefore are designed to be able to rotate about the substantially parallel direction axes of rotation L and M.

The cutter roll 2 is provided with a roll body 2a and shafts 2b. The shafts 2b are supported at the frame 4 through bearings 4a. The anvil roll 3 is also provided with a roll body 3a and shafts 3b. The shafts 3b are supported at the frame 4 through bearings 4b.

Here, the anvil roll 3 is designed to be able to displace together with the bearings 4b in the vertical direction. Therefore, the distance D between axes of the cutter roll 2 and anvil roll 3 can be adjusted. In this case, the anvil roll 3 is displaced in the vertical direction by elevation devices fastened to the bearings 4b such as pneumatic or oil hydraulic cylinders 4c.

The shafts 2b and 3b have gears 2c and 3c attached to them and engaging with each other. The cutter roll 2 and anvil roll 3 are rotated in opposite directions synchronized with each other by these gears 2c and 3c. Note that, in the cutting system shown in FIG. 1, drive devices (not shown) are connected to the shafts 2b of the cutter roll 2.

Furthermore, referring to FIG. 1, flanges or side rings 2d are provided at the two sides of the roll body 2a of the cutter roll 2. These flanges 2d contact the circumferential surface of the roll body 3a of the anvil roll 3.

Further, at the roll body 2a of the cutter roll 2, a cutting blade 2e is carried, while at the roll body 3a of the anvil roll 3, a receiving blade 3e is carried.

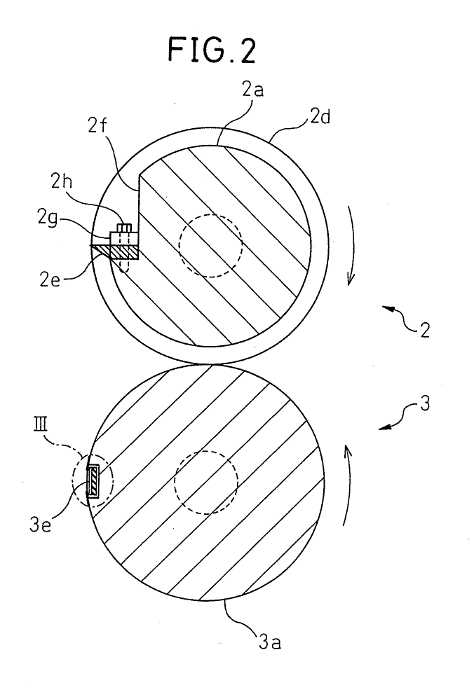

That is, as will be understood from FIG. 2 as well, the roll body 2a of the cutter roll 2 is formed with a recessed groove 2f extending in the axial L-L direction. The cutting blade 2e is fastened to the inner wall surface of this recessed groove 2f by washers 2g and bolts 2h. In the cutting system shown in FIG. 1, the cutting blade 2e is comprised of a flat blade extending in the axial L-L direction of the cutter roll 2 and is fastened so as to project out in the radial direction of the cutter roll 2. Naturally, the cutting blade 2e can also be comprised of another blade.

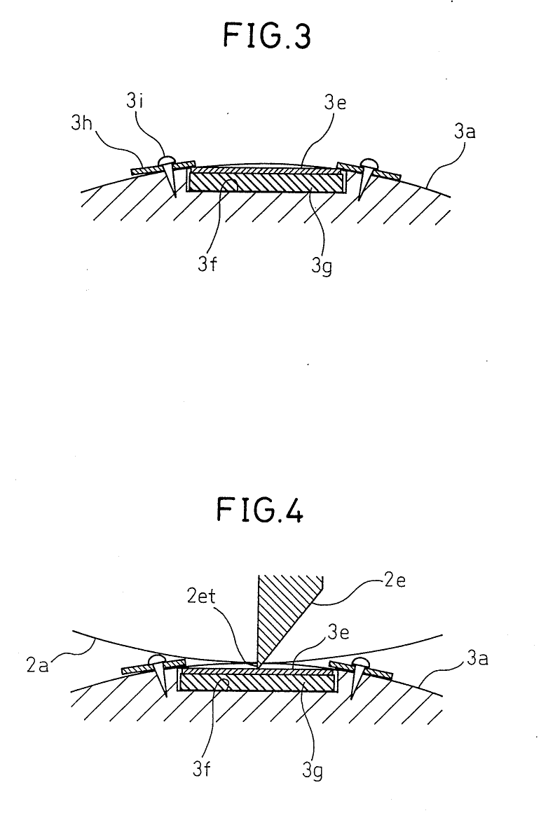

Further, as shown in FIG. 3 as well, the roll body 3a of the anvil roll 3 is formed at the circumferential surface with a recessed groove 3f extending in the axial M-M direction. A flat receiving blade 3e is held in the recessed groove 3f.

In this case, an elastic member 3g is interposed between the receiving blade 3e and the recessed groove 3f. The elastic member 3g is housed together with the receiving blade 3e in the recessed groove 3f. As a result, the receiving blade 3e is supported at the anvil roll 3 through the elastic member 3g.

At the two sides of the recessed groove 3f in the circumferential direction of the anvil roll 3, a pair of limit members 3h are fastened by fasteners 3i to the roll body 3a of the anvil roll 3. The elastic member 3g is housed in the recessed groove 3f in a compressed state and biases the receiving blade 3e outward in the radial direction. In this case, the receiving blade 3e strikes the limit members 3h, therefore displacement of the receiving blade 3e outward in the radial direction is limited.

When the receiving blade 3e is acted upon by force inward in the radial direction, the elastic member 3g is compressed and the receiving blade 3e separates from the limit member 3h and displaces inward in the radial direction. When the receiving blade 3e is no longer acted upon by force, the elastic member 3g springs back and the receiving blade 3e displaces outward in the radial direction and strikes the limit members 3h. In this way, the receiving blade 3e is designed to be able to elastically displace in the radial direction of the anvil roll 3.

Here, in the cutting system shown in FIG. 1, the cutting blade 2e is made from high strength steel having an HRC hardness of 60°, the receiving blade 3e is made from carbon steel having an HRC hardness of 52.5°, and the elastic material 3g is made from synthetic rubber or natural rubber such as urethane rubber having a hardness of HS90°. Note that the cutting blade 2e is preferably harder than the receiving blade 3e, but this is not essential.

Furthermore, in the cutting system shown in FIG. 1, the clearance between the cutting blade 2e and the receiving blade 3e is made to become a negative value by adjustment of the distance D between axes (FIG. 1) in advance. In other words, the positional relationship between the cutting blade 2e and the receiving blade 3e is set in advance so that when the cutting blade 2e and receiving blade 3e face each other, the cutting blade 2e will strike the receiving blade 3e.

Now then, the material to be cut is transported by a conveyor (not shown) in the substantially horizontal direction and fed into the cutting system 1, specifically, between the cutter roll 2 and the anvil roll 3. When the cutter roll 2 and the anvil roll 3 rotate and the cutting blade 2e and receiving blade 3e face each other, these cutting blade 2e and receiving blade 3e cut the material to be cut. The cut material is then transported further by the conveyor (not shown) in the substantially horizontal direction.

In this case, in the cutting system shown in FIG. 1, since the clearance is set to a negative value, the edge 2et of the cutting blade 2e reliably crosses the material to be cut to reach the receiving blade 3e, therefore can cut the material to be cut well.

Here, as shown in FIG. 4, when the cutting blade 2e strikes the receiving blade 3e, the receiving blade 3e displaces inward in the radial direction of the anvil roll 3 whereby the impact force acting on the cutting blade 2e is absorbed. Therefore, even when setting the clearance to a negative value, wear and chipping of the cutting blade 2e are suppressed and the lifetime of the cutting blade 2e is prolonged.

Further, when heat expansion, vibration, etc. of the cutter roll 2, anvil roll 3, cutting blade 2e, or receiving blade 3e causes the clearance to fluctuate, the amount of displacement of the receiving blade 3e in the radial direction will fluctuate and therefore the impact force acting on the cutting blade 2e will be absorbed. Therefore, in this case as well, good cutting of the material to be cut is secured while the lifetime of the cutting blade 2e is prolonged.

Furthermore, since wear and chipping of the cutting blade 2e are suppressed, the edge 2et of the cutting blade 2e can be made sharper and therefore the material to be cut can be cut better.

In this regard, if the width of the edge 2et of the cutting blade 2e is large, that is, the edge 2et is dull, the material to be cut will be crushed by the cutting blade 2e while being cut and press bonding or heat bonding of the material to be cut is liable to occur near the cut surface. When the material to be cut includes tow etc. where the fibers are not bonded with each other, the press bonding or heat bonding is liable to detract from the fluffy state of the material to be cut. Alternatively, the material to be cut will be incompletely cut and the material to be cut is liable to be left with uncut pieces etc.

As opposed to this, in this embodiment of the present invention, the edge 3et of the cutting blade 2e can be made sharp, so the material to be cut can be cut well. That is, it is possible to suppress press bonding and melt bonding from occurring around the cut surfaces and possible to maintain a fluffy state of the material to be cut.

Further, sometimes the polishing applied to the edge 2et of the cutting blade 2e in advance or flexing of the cutting blade 2e itself will result in unevenness of the edge 2et in the longitudinal direction. In the past, to reduce this unevenness, the cutting blade 2e was cylindrically polished. In this regard, if cylindrically polishing it, the width of the edge 2et of the cutting blade 2e is liable to become greater.

As opposed to this, in this embodiment of the present invention, the receiving blade 3e elastically deforms in the radial direction, so the effects of unevenness of the edge 2et are absorbed. As a result, cylindrical polishing of the cutting blade 2e becomes unnecessary and therefore the cutting blade 2e can be maintained sharp.

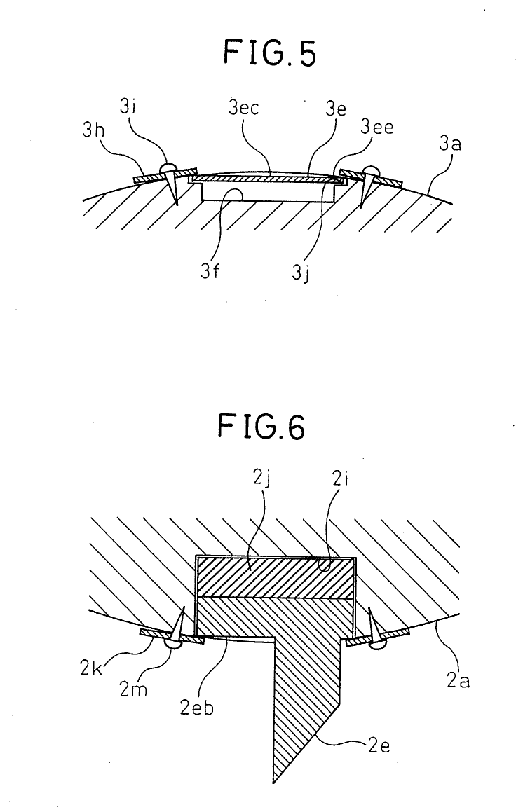

FIG. 5 shows another embodiment according to the present invention.

Referring to FIG. 5, at the two sides of the recessed groove 3f in the circumferential direction of the anvil roll 3, a pair of receiving grooves 3j extending in the axial M-M direction are formed. The two ends 3ee of the receiving blade 3e in the circumferential direction of the anvil roll 3 are housed in the receiving grooves 3j and are fastened by the limit members 3h. That is, the receiving blade 3e is supported at the anvil roll 3 at the two ends in the circumferential direction of the anvil roll 3.

In the example shown in FIG. 5, when the cutting blade 2e strikes the receiving blade 3e, the center 3ec of the receiving blade 3e flexes inward in the radial direction. As a result, the impact force acting on the cutting blade 2e can be absorbed.

Note that, in the example shown in FIG. 5, the receiving blade 3e is supported at its two ends. However, the receiving blade 3e may also be supported at one end.

FIG. 6 shows still another embodiment of the present invention.

Referring to FIG. 6, a recessed groove 2i is formed extending in the blade axial L-L direction in the circumferential surface of the roll body 2a of the cutter roll 2. The base 3eb of the cutting blade 2e is housed inside the recessed groove 2i.

In this case, a compressed state elastic member 3j is interposed between the cutting blade 2e and the recessed groove 2i. The elastic member 2j is housed together with the cutting blade 2e in the recessed groove 2i. As a result, the cutting blade 2e is supported at the cutter roll 2 through the elastic member 2j.

At the two sides of the recessed groove 2i in the circumferential direction of the cutter roll 2, a pair of limit members 2k are affixed by fasteners 2m to the roll body 2a of the cutter roll 2 and limit displacement of the cutting blade 2e outward in the radial direction.

If the cutting blade 2e strikes the receiving blade 3e, the elastic member 2j is compressed and the cutting blade 2e separates from the limit members 2k and displaces inward in the radial direction. When the cutting blade 2e no longer is acted upon by any force, the elastic member 2j springs back and the cutting blade 2e displaces outward in the radial direction to strike the limit members 2k. In this way, the cutting blade 2e can elastically displace in the radial direction of the cutter roll 2. Even if so designed, it is possible to secure good cutting while extending the lifetime of the cutting blade 2e.

In this case, the receiving blade 3e may be able to displace in the radial direction of the anvil roll 3 or not be able to displace there. Alternatively, the receiving blade 3e may be omitted and the circumferential surface of the roll body 3a of the anvil roll 3 may act as the receiving blade.

### REFERENCE SIGNS LIST

1 cutting system
2 cutter roll
2e cutting blade
3 anvil roll
3e receiving blade
3g elastic member

1. A cutting system provided with a cutter roll and an anvil roll rotating in opposite directions to each other about substantially parallel axes of rotation, these cutter roll and anvil roll respectively carrying a cutting blade and a receiving blade, the cutting system cutting a material to be cut which is fed between these cutter roll and anvil roll, by the facing cutting blade and receiving blade, wherein the receiving blade can elastically displace in a radial direction of the anvil roll.

2. A cutting system as set forth in claim 1, wherein the receiving blade is supported by the anvil roll through an elastic member.

3. A cutting system as set forth in claim 2, wherein a recessed groove is formed in the circumferential surface of the anvil roll, and the receiving blade and elastic member are held in said recessed groove.

4. A cutting system as set forth in claim 1, wherein the receiving blade is supported at ends in a circumferential direction of the anvil roll so that the receiving blade flexes at a center in a circumferential direction of the anvil roll.

5. A cutting system as set forth in claim 1, wherein a positional relationship between the cutting blade and receiving blade is set in advance so that when the cutting blade and receiving blade face each other, the cutting blade strikes the receiving blade.

6. A cutting system as set forth in claim 1, wherein the material to be cut is at least one material selected from a nonwoven fabric, paper, a fiber aggregate, and a plastic film.

7. A cutting system provided with a cutter roll and an anvil roll rotating in opposite directions to each other about substantially parallel axes of rotation, the cutting system cutting a material to be cut which is fed between these cutter roll and anvil roll, by a cutting blade carried on the cutter roll, wherein the cutting blade can elastically displace in a radial direction of the cutter roll.
